(19) United States
(12) Patent Application Publication
(10) Pub. No.: US 2019/0274266 A1
(43) Pub. Date: Sep. 12, 2019

(54) METHOD AND SYSTEM FOR CAPABLE OF SELECTING OPTIMAL PLANT CULTIVATION METHOD

(71) Applicant: LAND GREEN AND TECHNOLOGY CO., LTD., Taipei City (TW)

(72) Inventor: LID FU, Taipei City (TW)

(21) Appl. No.: 16/423,140

(22) Filed: May 27, 2019

Related U.S. Application Data
(62) Division of application No. 15/351,447, filed on Nov. 15, 2016.

(51) Int. Cl. A01G 31/02; A01G 22/00; C02F 9/00; A01G 25/02

(52) U.S. Cl. CPC A01G 31/02; A01G 22/00; C02F 1/001; A01G 25/023; C02F 9/00

(57) ABSTRACT

A system capable of selecting an optimal plant cultivation method mainly includes a plurality of water supply units, a water treatment unit, a plurality of nutrition units, a reactor, a plurality of gas supply units, a liquid storage unit, at least three growth boxes, an information device. A method capable of selecting an optimal plant cultivation method allows participants of a competition in every place of the world to operate the same greenhouse facilities together at the same time, and grow the same plant or a several types of plants at the same time, latitude and location. But, every participant themselves may use the facilities provided in the greenhouse to adjust and control other growing conditions, environmental factors, cultivation methods and nutrition formulas, and the best cultivation method and nutrition formula are selected, thereby finding out the best cultivation method of the plant when the competition is over.

### CROSS-REFERENCE

This is a division of the co-pending patent application Ser. No. 15/351,447 filed Nov. 15, 2016.

### (a) TECHNICAL FIELD OF THE INVENTION

The present invention relates to plant cultivation, and more particularly to a method and system capable of selecting an optimal plant cultivation method.

### (b) DESCRIPTION OF THE PRIOR ART

Nowadays there is a problem of food in the world. Insufficient and inadequate diet of a significant part of the world's population has a huge impact on the biological and social aspects of all mankind reproduction.

Millions of people continue to die because of hunger, malnutrition, disease, or of causes related to poor-quality food. For the same reason, of poor-quality food, there are growing numbers of different diseases every year including cancer. The sources of such food in many cases are plants. Therefore, to find new, optimal ways to increase productivity and usefulness of plants is more and more important.

While some countries spend big money on research of new ways to increase the productivity and quality of plants, and at the same time, many people invest their own funds to the different studies, a method and platform capable of selecting optimal plant cultivation method are not found in the world up to the present.

### SUMMARY OF THE INVENTION

One object of the present invention is to provide a system capable of selecting an optimal plant cultivation method.

to achieve the object mentioned above, the system of the present invention includes a plurality of water supply units, a water treatment unit, a plurality of nutrition units, a reactor, a plurality of gas supply units, a liquid storage unit, at least three growth boxes, an information device, where the plurality of water supply units are used to accommodate a plurality of water sources, the water treatment unit is connected to the water supply units and adapted to filter, purify and modify the water sources, the plurality of nutrition units are used to accommodate nutrition, each nutrient unit is delivered to a mixing device by means of a conveying device, where the mixing device is in connection with the water treatment unit and adapted to mix with the filtered water and nutrition to become nutrition solution; the reactor is in connection with the water treatment unit and mixing device, and adapted to prepare predetermined qualities of nutrition solutions by means of different control actions; the plurality of gas supply units are adapted to accommodate a plurality of gases and supply the gases to the reactor to mix with the filtered, purified and modified water and the nutrition solutions to prepare a nutrition formula for plant roots or stems; the liquid storage unit is in connection with the reactor and water treatment unit, and used to store the nutrition formula and filtered, purified and modified water; each of the at least three growth boxes is used to accommodate plants and in connection with the gas supply units and liquid storage unit, and includes a plurality of controlling elements and a cultivation unit, where the controlling elements are used to control the growth conditions of the plants and the cultivation unit is used to switch selectively among an aeroponic module, drip irrigation module and hydroponic module; the information device is in connection with a servo control unit in a stationary connection or wireless transmission way, and used to control the control actions of the reactor and the operations of the controlling elements of the growth box through the commands of the servo control unit.

Another object of the present invention is to provide a method capable of selecting an optimal plant cultivation method.

To achieve the object mentioned above, the method of the present invention includes:
a. providing a plurality of participants with a cultivation system capable of selecting an optimal cultivation method for carrying out a plant cultivation competition;
b. establishing the eligibility of the plant cultivation competition;
c. establishing a growing method in the plant cultivation competition, the growing method being aeroponics, drip irrigation or hydroponics;
d. establishing types of plants in the plant cultivation competition;
e. combining the growing methods with the plant types so as to carry out a variety of plant cultivation competitions, the participants choose the growing methods and plant types;
f. announcing competition starting date and participants registration period through media, all participants finish registration process and pay an access fee on the website;
g. giving all participants required seedlings and one incubator containing at least three growing boxes; allowing participants to cultivate seedlings with three different conditions or using three different growth formulas at the same time, which gives more chances to succeed;
h. adjusting and controlling plant growing conditions, growing methods and nutrition formula in the growth boxes by the participants by selecting a plurality of controlling elements, cultivation units and reactor provided by the plant cultivation system of the optimal plant cultivation method;
i. choosing the best one growing box out of three and submitting it to selection committee by participants after the competition finishes, the committee selecting the best growing method and nutrition formula, thereby finding out the best cultivation methods of the plants; and
j. selecting the best plant cultivation method according to the types of the plants, and judging and rating the specifications of the types of the plants.

### BRIEF DESCRIPTION OF THE DRAWINGS

FIG. 1 is a schematic view of the a system of a first preferred embodiment according to the present invention;

FIG. 2 is a schematic view of water supply units and water treatment unit of the present invention;

FIG. 3 is a schematic view of a nutrition unit of the present invention;

FIG. 4 is a schematic view of a reactor of the present invention;

FIG. 5 is a schematic view of gas supply units of the present invention′

FIG. 6 is a schematic view of growth boxes of the present invention; and

FIG. 7 is a system view of a second preferred embodiment of the present invention.

### DETAILED DESCRIPTION OF THE PREFERRED EMBODIMENTS

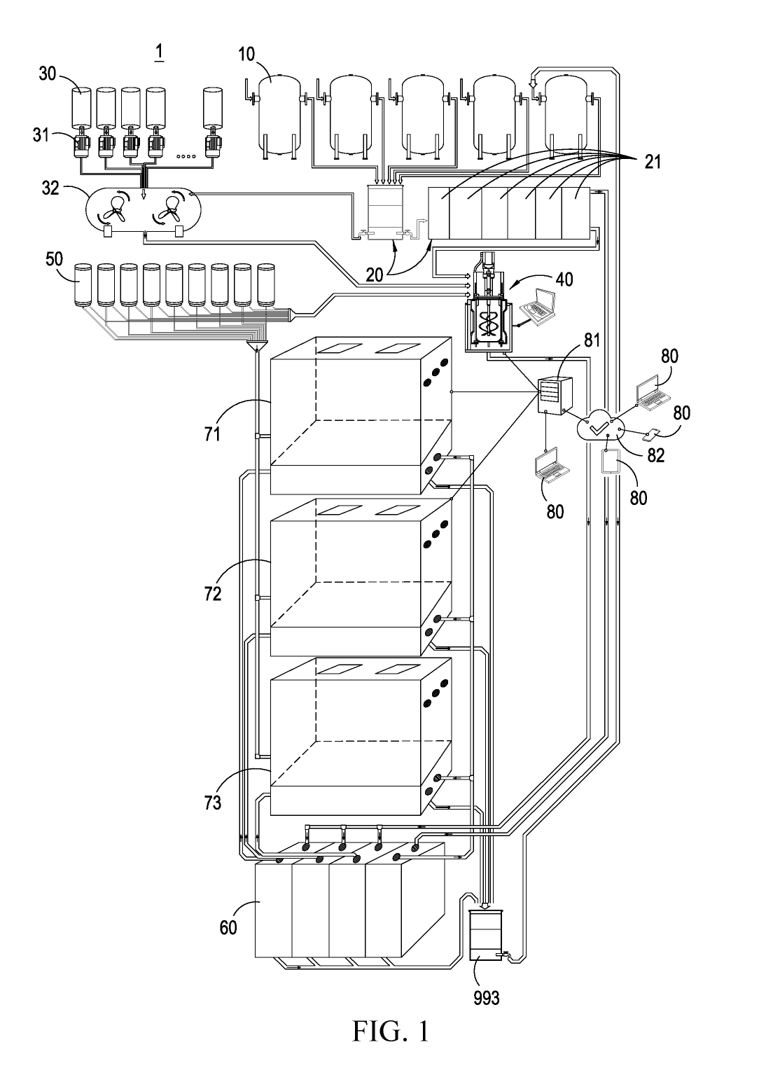

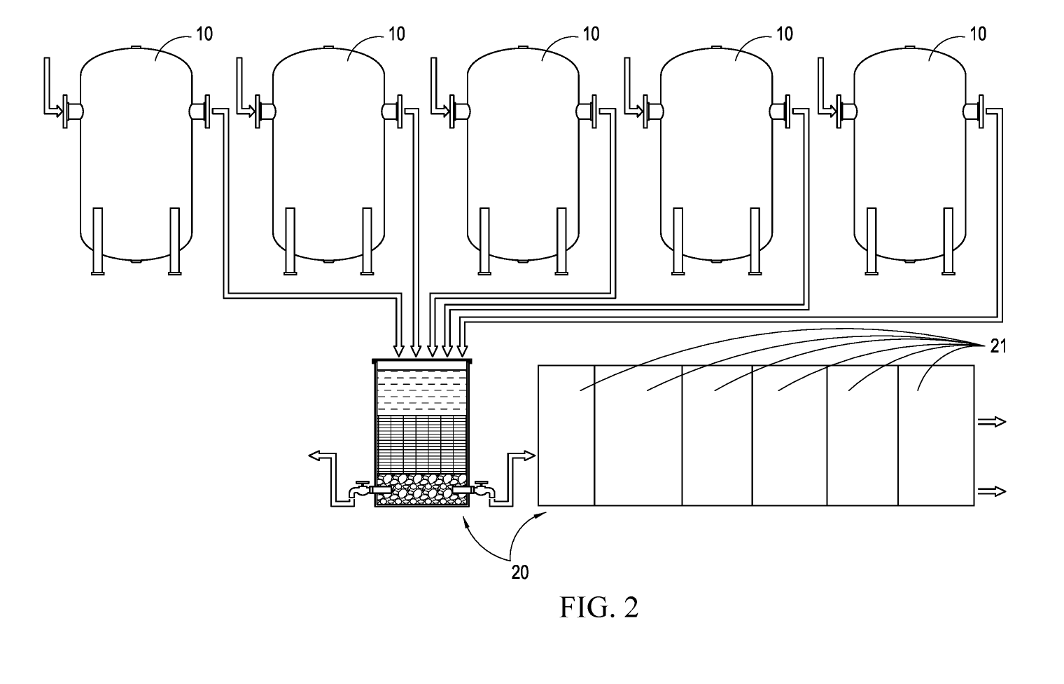

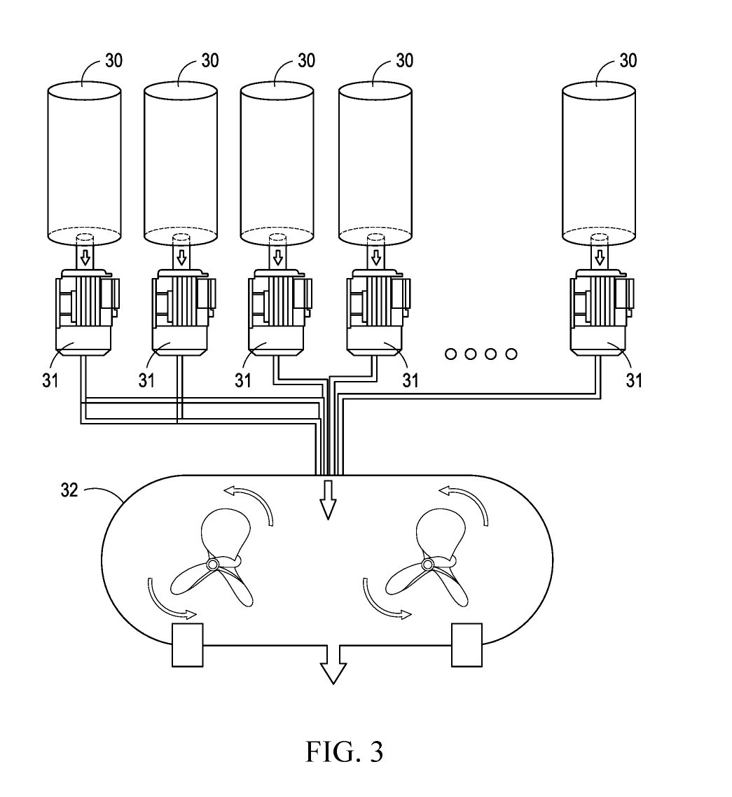

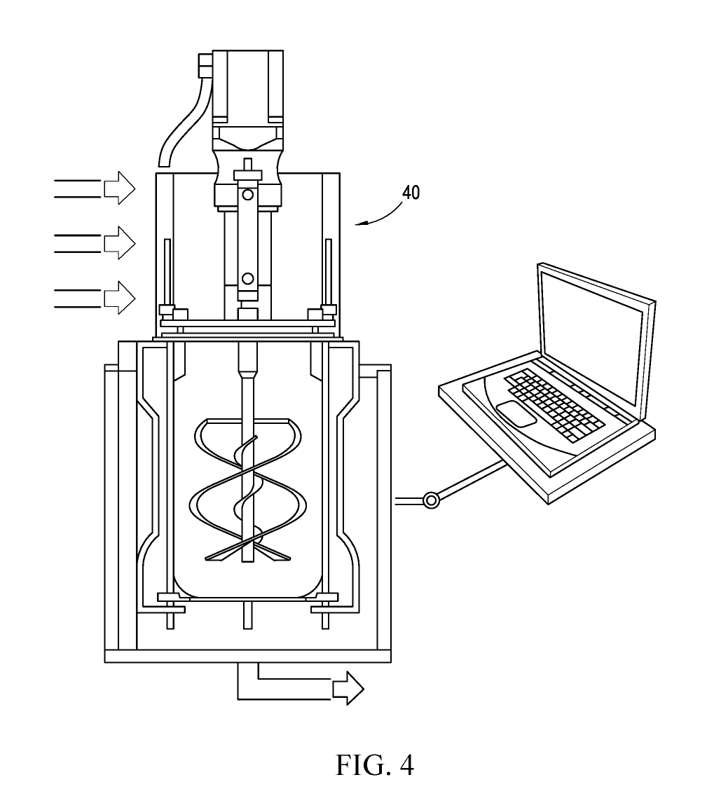

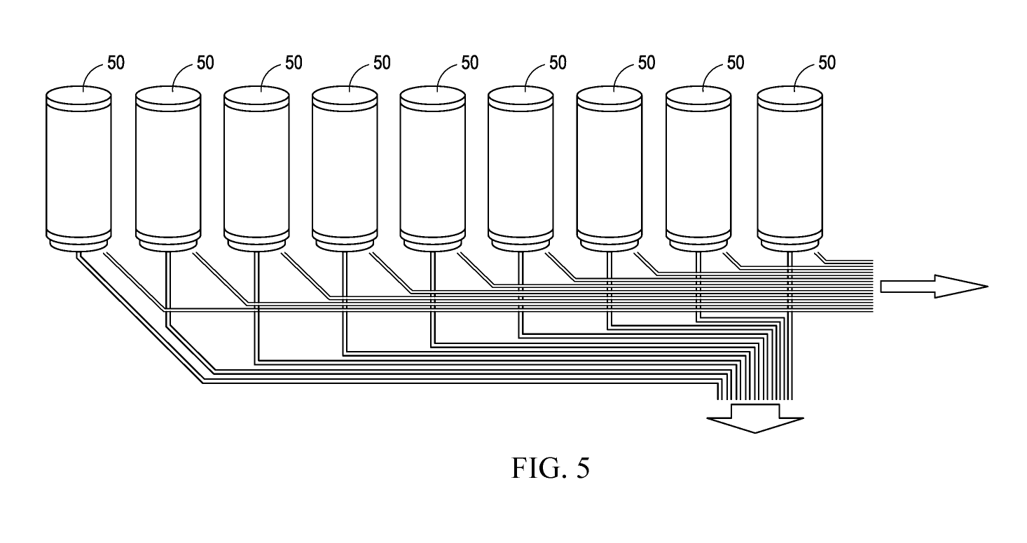

Referring to FIGS. 1 to 6, a plant cultivation system 1 capable of selecting an optimal plant cultivation method according to the present invention includes a plurality of water supply units 10, a water treatment unit 20, a plurality of nutrition units 30, a reactor 40, a plurality of gas supply units 50, a liquid storage unit 60, at least three growth boxes 71, 72, 73, and an information device 80.

The plurality of water supply units 10 are used to accommodate a plurality of kinds of water sources.

The water treatment unit 20 is connected to the water supply units and adapted to filter, purify and modify the water sources.

The plurality of nutrition units 30 are used to accommodate nutrition, each nutrient unit 30 is delivered to a mixing device 32 through a conveying device 31, where the mixing device is in connection with the water treatment unit 20 and adapted to mix the filtered water with nutrition to become nutrition solution.

The reactor 40 is in connection with the water treatment unit 20 and adapted to prepare predetermined qualities of nutrition solutions by means of different control actions.

the control actions of the reactor 40 includes a mixing function, mixing speed control function, temperature control with heating and cooling function, electrical conductivity control and change function, PH control, particle size control function, function of automatic feed of solution to the tank section (nutrient solution storage) of incubator, and may have other functions on user demand.

the plurality of gas supply units 50 are adapted to accommodate a plurality of kinds of gases and supply the gases to the reactor 40 to mix with the filtered, purified and modified water and the nutrition solutions to prepare a nutrition formula for plant roots or stems.

The liquid storage unit 60 is in connection with the reactor 40 and water treatment unit 20, and used to store the nutrition formula and filtered, purified and modified water.

Each of the at least three growth boxes 71, 72, 73 is used to accommodate the same kind of plant and in connection with the gas supply units 50 and liquid storage unit 60 to input the gas, nutrition formula and modified, purified and modified water, and includes a plurality of controlling elements and a cultivation unit, where the controlling elements are used to control the growth conditions of the plants and the cultivation unit is used to switch selectively among an aeroponic module 741, drip irrigation module 742 and hydroponic module 743.

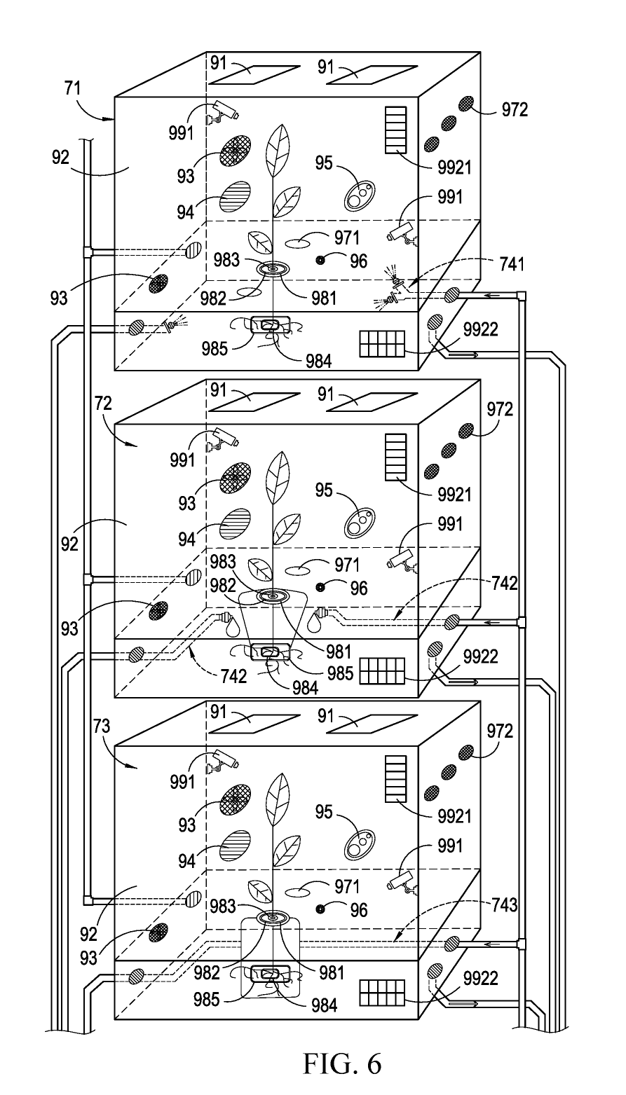

The growth box 71, as FIG. 6 shows, is switched selectively to an aeroponic module, the growth box 72 a drip irrigation module 742, and the growth box 73 a hydroponic module 743. But, the participants may respectively be switched to the aeroponic module 741, drip irrigation module 742 or hydroponic module 743 in accordance with the provisions upon the competition.

The information device 80 is in connection with a servo control unit 81 in a stationary connection or wireless transmission way, and used to control the control actions of the reactor 40 and the operations of the controlling elements of the growth boxes 71, 72, 73 through the commands of the servo control unit 81.

The information device 80, as FIG. 1 shows, is in connection with the servo control unit 81 through internet 82.

The information device 80 may be a notebook computer, mobile phone, or tablet computer.

In a preferred embodiment, the plurality of water supply units 10 number 5, respectively being rainwater, tap water, distilled water, aquaponics system water and other water.

In a embodiment, the water treatment unit 20 includes a plurality of water treatment means 21, numbering 6 and respectively being O₃, water magnetization, UV lighting, electrolysis of water, low frequency sound, and other possible treatments means. Applied functions can impart various properties to the water which influence the plants growth. Then modified water runs to the main reactor 40 to produce the final formula of nutrients solution for plants.

In one embodiment, nutrition accommodated in the plurality of nutrition unit 30 includes microelements, macroelements, biologically active additives and bacteria.

The microelements includes Co, Mn, Cu, Fe, Ag, I, Mo, V, Se, Zn, Li, B, Ni, F.

The macroelements includes P, Ca, K, C, Mg, Na, and S.

In one embodiment, the plurality of gas supply units 50 number 8, respectively accommodating CO₂, O₂, O₃, H₂, NO, N₂, C₂H₄, H₂S and other kinds of gases.

In one embodiment, the liquid storage unit 60 has at least four grooves respectively stored with at least three kinds of nutrition solution formulas and the filtered, purified and modified water, and the at least three kinds of nutrition solution formulas are delivered to the three growth boxes 71, 72, 73.

In one embodiment, the controlling elements of each of the growth boxes 71, 72, 73 include a plurality of light sources 91, a light source 92, a plurality of fans 93, AC (heater and cooler) 94, speaker 95, UV light source 96, gas exhaust 972, gas input 981, magnetic ring 982, stein heater 983, electric unit 984, vibration unit 985, where the light source 92 is configured on one side wall of each of the growth boxes 71, 72, 73, and the gas input 981, magnetic ring 982, stein heater 983, electric unit 984, vibration unit 985 are arranged closely to the plant.

The speaker 95 is used to play music to promote the growth of plants.

The light source 92 is selected from LED, having the functions of setting infrared light (IR), ultraviolet light (UV) and general visible light and adjusting light strength, color, wavelength, etc.

The magnetic ring 982 may numbers one and more, capable of being configured outside plant stems, and also configured at plant roots and leaves.

The electric unit 984 is adapted to apply current to the plant, and the vibration unit 985 vibrates the plant, thereby stimulating the plant growth.

In one embodiment, the growth boxes 71, 72, 73 include a plurality of monitoring units 991 and a plurality of sensors 9921, 9922, where the sensor 9921 is used to sense plant stems, and the sensor 9922 plant roots, where the sensors 9921, 9922 respectively have an inbuilt processing unit (CPU) and software, which will compare whether the user's original preset values are met according the information such as environmental factors transmitted back from the sensors 9921, 9922 inside the growth boxes 71, 72, 73; if not, the CPUs and software inside the sensors 9921, 9922 will emit commands automatically to start the controlling elements to make the environmental factors inside the growth boxes 71, 72, 73 meet the user's preset values.

The plurality of sensors 9921 may sense chlorophyll, the amount of gas, temperature, humidity, brightness, etc

The sensor 9922 may sense temperature, humidity, ammonia (NH4+), redox value (ORP), nitrate (NO3-), nitrites (NO2-), dissolved oxygen, weight, liquid height detector (level sensor), PH value, turbidity, etc.

In one embodiment, the system 1 capable of selecting an optimal plant cultivation method according to the present invention further includes a filtering unit 993 in connection with the growth boxes 71, 72, 73, liquid storage unit 70 (60) and water supply units 10, adapted to filter the liquid drained out of the growth boxes 71, 72, 73 and liquid unit 60, and allowing the liquid to flow back to the water supply units 10 for recycling.

In one embodiment, the at least three growth boxes 71, 72, 73 are arranged perpendicularly for the cultivation of low plants.

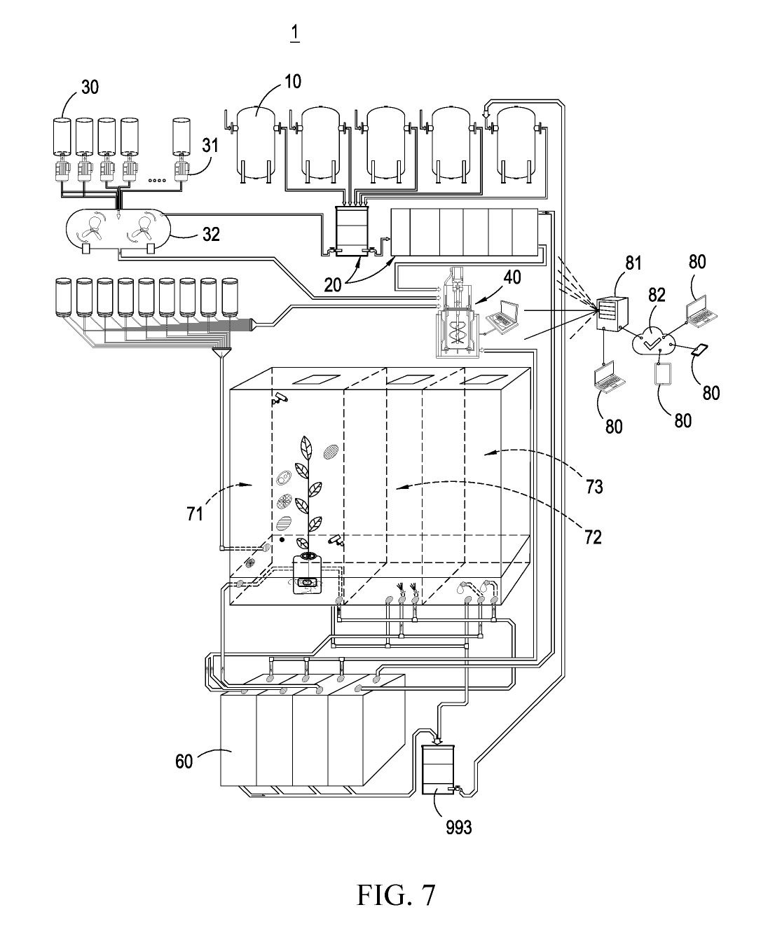

Referring to FIG. 7, in one embodiment, the at least three growth boxes 71, 72, 73 are arranged transversely for the cultivation of tall plants.

Furthermore, a method capable of selecting an optimal plant cultivation method includes:
a. providing a plurality of participants with a cultivation system capable of selecting an optimal cultivation method for carrying out a plant cultivation competition;
b. establishing the eligibility of the plant cultivation competition;
c. establishing a growing method in the plant cultivation competition, the growing method being aeroponics, drip irrigation or hydroponics;
d. establishing types of plants in the plant cultivation competition;
e. combining the growing methods with the plant types so as to carry out a variety of plant cultivation competitions, the participants choose the growing methods and plant types;
f. announcing competition starting date and participants registration period through media, all participants finish registration process and pay an access fee on the website;
g. giving all participants required seedlings and one incubator containing at least three growing boxes 71, 72, 73; allowing participants to cultivate seedlings with three different conditions or using three different growth formulas at the same time, which gives more chances to succeed;
h. adjusting and controlling plant growing conditions, growing methods and nutrition formula in the growth boxes 71, 72, 73 by the participants by selecting a plurality of controlling elements, cultivation units and reactor 40 provided by the plant cultivation system 1 of the optimal plant cultivation method;
i. choosing the best growing box out of three and submitting it to selection committee by participants after the competition finishes, the committee selecting the best growing method and nutrition formula, thereby finding out the best cultivation methods of the plants; and
j. selecting the best plant cultivation method according to the kinds of the plants, and judging and rating the specifications of the kinds of the plants.

Referring to FIG. 7, how the present invention applies a “cybernetic remote control system” is further described. A participants in any corner of the world may use the information device 80 to connect with the servo control unit 81 in a fixed or wireless transmission way, and control the control action of the reactor 40 and the operation of the controlling elements of the growth boxes 71, 72, 73 through the control software, programs and commands preset by the servo control unit 81.

Accordingly, the present invention may control plant growth factors and nutrient supply of the growth boxes 71, 72, 73 remotely, the remote control being acted at least as the following:

1. selecting the dosing and mixing of liquid nutrients;

2. choosing water and water regulation;

3. choosing the mixing of gas and nutrient;

4. preparing the final formulation of nutrient liquid in the reactor 40;

5. controlling the growth factors of plant roots;

6. controlling the growth factors of plant stems; and

7. archiving and analyzing plant growth process statistical data.

The present invention has the following advantages:
1. a new platform for remote research, especially for those who cannot conduct their own research and experiments on the growth of plants in required and necessary test conditions;
2. the participants in every place of the world can operate the same greenhouse facilities together at the same time, and grow the same plant or a several types of plants at the same time, latitude and location. But, every participant themselves may use the facilities provided in the greenhouse to adjust and control other growing conditions, cultivation methods and nutrition formulas, and the best cultivation method and nutrition formula are selected, thereby finding out the best cultivation method of the plant when the competition is over;
3. people all over the world and even in outer space can use the cultivation facilities of the present invention to study, test the cultivation methods and nutrition formulas of the plants only through internet;
4. the participants in any place of the world can use the cultivation facilities of the present invention to simulate experimental cultivations such as a variety of temperatures, humidity, soil textures, gases, pHs, sunlight, and then select the one having the best effect among a variety of experimental cultivation methods and formulas, which is used for formal cultivation use in the future so that the participants may only stay at home or a work place to carry out experiments simply through internet with no need of a long journey to specific fields and laboratories and does not have to build laboratories by themselves. In addition, the same plant can be grown by means of a variety of methods at the same time, the experimental cost and time decreased substantially, and uncertain factors (e.g. place-to-place four seasons temperature, temperature and humidity, soil, pH value, air quality difference, sunshine difference) reduced significantly the experiments so carried out can obtain the best cultivation method and nutrition formula for each kind of plant.
5. the research results can be used immediately on greenhouse agriculture, commercialized directly; the installation of the same facilities all over the world to culture plants will not be restrained and affected by local climate difference.
6. in traditional cultivation, people need work actually in the field such that they must be strong. But, people with disabilities can even carry out plant cultivation and much more research an optimal plant cultivation methods and formulas only by controlling a computer or mobile device with network.

I claim:

1. A method capable of selecting an optimal plant cultivation method, comprising:
a. providing a plurality of participants with a cultivation system capable of selecting an optimal cultivation method for carrying out a plant cultivation competition;
b. establishing the eligibility of said plant cultivation competition;
c. establishing a growing method in said plant cultivation competition, said growing method being aeroponics, drip irrigation or hydroponics;
d. establishing types of plants in said plant cultivation competition;
e. combining said growing methods with said plant types so as to carry out a variety of plant cultivation competitions, said participants choose said growing methods and plant types;
f. announcing competition starting date and participants registration period through media, all participants finish registration process and pay an access fee on the website;
g. giving all participants required seedlings and one incubator containing at least three growing boxes; allowing participants to cultivate seedlings with three different conditions or using three different growth formulas at the same time, which gives more chances to succeed;
h. adjusting and controlling plant growing conditions, environmental factors, growing methods and nutrition formula in said growth boxes by said participants by selecting a plurality of controlling elements, cultivation units and reactor provided by said plant cultivation system of said optimal plant cultivation method;
i. choosing the best one growing box out of three and submitting it to selection committee by participants after said competition finishes, said committee selecting the best growing method and nutrition formula, thereby finding out the best cultivation methods of the plants; and
j. selecting the best plant cultivation method according to types of said plants, and judging and rating the specifications of said types of said plants.
